(19) United States
(12) Patent Application Publication
(10) Pub. No.: US 2002/0114125 A1
(43) Pub. Date: Aug. 22, 2002

(54) Capacitance type humidity sensor and manufacturing method of the same

(76) Inventors: Inao Toyoda, Okazaki-city (JP); Hajime Matsuhashi, Nagoya-city (JP); Kazushi Asami, Okazaki-city (JP)

Correspondence Address: LAW OFFICE OF DAVID G POSZ, 2000 L STREET, N.W., SUITE 200, WASHINGTON, DC, 20036, US

(21) Appl. No.: 10/054,978

(22) Filed: Jan. 25, 2002

(30) Foreign Application Priority Data
Feb. 20, 2001 (JP) 2001-43973

(51) Int. Cl. H01G 5/012; H01G 5/013

(52) U.S. Cl. 361/286

(57) ABSTRACT

A capacitance type humidity detecting sensor has two electrodes which face with each other with a gap interposed therebetween to form a capacitance on a silicon substrate having a silicon oxide film on a surface thereof. A humid-sensitive film is formed so as to cover the two electrodes with a silicon nitride film interposed therebetween to protect the electrodes from water passing through the humid-sensitive film. The capacitance between the two electrodes changes in accordance with ambient humidity of the sensor. A switched capacitor circuit formed in a circuit element portion processes a signal which contains change in the capacitance between the two electrodes.

### CROSS REFERENCE TO RELATED APPLICATION

This application is based upon Japanese Patent Application No. 2001-43973 filed on Feb. 20, 2001, the contents of which are incorporated herein by reference.

### BACKGROUND OF THE INVENTION

1. Field of the Invention

The present invention relates to a capacitance type humidity sensor in which a humid-sensitive film is disposed between two electrodes to increase permittivity of a capacitance formed between the two electrodes, and to a manufacturing method of the same.

2. Related Art

As is disclosed in JP-A-60-166854, this kind of sensor has a substrate as a lower electrode, a humid-sensitive film formed on the substrate, and a thin upper electrode having humidity permeability. However, the upper electrode is exposed to a circumstance, and therefore, the upper electrode is required high resistivity against the circumstance.

To the contrary, as is disclosed in JU-A-5-23124 or JP-A-7-20080, a sensor, in which two electrodes are formed on an identical plane of a substrate to face with each other, and a humid-sensitive film is formed on these two electrodes, has been proposed. However, a resistance detection type sensor is mainly disclosed in these references while a capacitance detection type sensor is merely described a little without a detailed description and figures.

Besides, although the electrodes are disposed under the humid-sensitive film, the electrodes are exposed to water. Therefore, a problem arises which relates to water resisting property.

In the above-described sensor, precious metal should be employed to secure reliability of the electrodes against humidity. However, the precious metal increases manufacturing cost. Besides, the precious metal becomes contaminants in a manufacturing process.

### SUMMARY OF THE INVENTION

An object of the invention is to provide a humid-sensitive sensor which has high reliability and can be produced in a semiconductor process line, and a manufacturing method of the same.

According to an aspect of the present invention, a first insulation film is formed on a semiconductor substrate. First and second electrodes are disposed on the first insulation film and face with each other with a gap interposed therebetween. A second insulation film is formed so as to cover the first and second electrodes. Moreover, a humid-sensitive film is formed so as to cover the second insulation film.

In this structure, the second insulation film is interposed between the first and second electrodes and the humid-sensitive film, so that a water resisting property of the electrodes can be secured.

By the way, the sensor disclosed in JU-A-5-23124 has a dielectric material as a base plate, and therefore a discrete circuit board is required. The sensor plate is electrically connected to the circuit plate by wirings which increase stray capacitance. Therefore, capacitance in a detection portion should be designed so as to be large to increase signal component against noise component. As a result, sensor body inevitably becomes large.

According to a second aspect of the present invention, a circuit portion is integrated in the semiconductor substrate in which a humid-sensitive sensing portion is formed. The circuit portion processes signals transmitted from the sensing portion.

Preferably, the first and second electrodes are composed of the same material as that of wiring in the circuit portion. Thus, the electrodes and the wiring are formed in the same step.

Preferably, the circuit portion includes a switched capacitor circuit. The switched capacitor circuit can detects small amount of capacitance sensitively.

Preferably, the second insulation film is composed of a silicon nitride film. The silicon nitride film relatively has a high dielectric constant, so that capacitance between the first and second electrodes increases.

Preferably, the first insulation film is composed of a material that has a dielectric constant lower than that of the second insulation film. Thus, parasitic capacitance between the electrodes and the substrate can be decreased.

Incidentally, a molecular organic material that has a high hygroscopicity, such as polyimide or butyric acetylcellulose, can be employed as the humid-sensitive film.

Preferably, the respective electrodes have a comb-teeth-shape having electrode portions, and the electrode portions of the first electrode are engaged with those of the second electrode to increase a facing area between the electrode portions of the first electrode and the electrode portions of the second electrode.

Incidentally, the electrodes may be composed of one of Al, Al—Si, Ti, Au, Cu, and poly-Si, or a compound composed of at least two of these materials.

Preferably, the humid-sensitive film is disposed so that a surface thereof contacting the second insulation film is located lower than surfaces of the first and second electrodes between the electrodes, to thereby dispose the humid-sensitive film surely in the gap formed between the electrodes.

Incidentally, after the circuit portion is formed, then the sensing portion is formed.

Other features and advantages of the present invention will become more apparent from the following detailed description made with reference to the accompanying drawings.

### BRIEF DESCRIPTION OF THE DRAWINGS

FIG. 1 is a schematic plan view of a capacitance type humidity sensor of the present invention;

FIG. 2 is a schematic cross sectional view taken along line II-II in FIG. 1;

FIGS. 3A to 3C are schematic cross sectional views taken along line III-III in FIG. 1, showing a manufacturing method of the capacitance type humidity sensor of the present invention;

FIG. 4 is a schematic circuit diagram of the capacitance type humidity sensor of the present invention; and

FIG. 5 is a timing chart for the circuit diagram in FIG. 4.

### DETAILED DESCRIPTION OF THE PREFERRED EMBODIMENT

Specific embodiments of the present invention will now be described hereinafter with reference to the accompanying drawings in which the same or similar component parts are designated by the same or similar reference numerals.

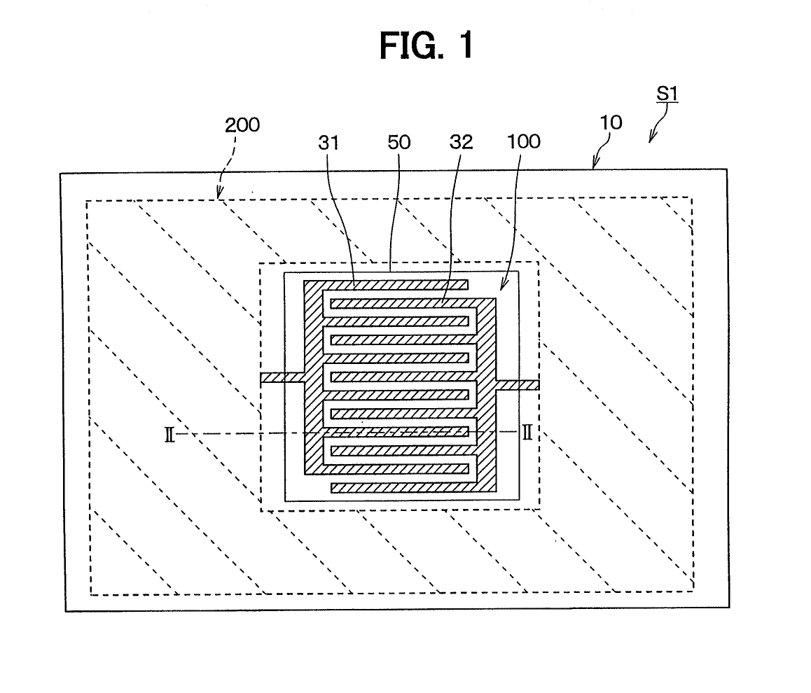

A humidity sensor S1 shown in FIG. 1 may be used for humidity control in an air conditioner or to detect humidity in the outside for weather observation.

An N-type silicon substrate is employed as a semiconductor substrate 10. A silicon oxide film 20 is formed on the semiconductor substrate 10 as a first insulation film. First and second electrodes 31, 32 (hereinafter, referred to as detection electrodes) are formed on an identical plane of the silicon oxide film 20 so as to face with each other with a gap interposed therebetween.

Although shape of the detection electrodes 31 and 32 is not restricted, in this embodiment, the electrodes 31 and 32 have a comb-teeth-shape pattern constituted by a plural electrode portions, respectively. The plural electrode portions have a bar-like shape, respectively, and the plural electrode portions of the detection electrode 31 are engaged with those of the detection electrode 32, thereby decreasing an arrangement area for the detection electrodes 31 and 32.

A material capable of using in a usual semiconductor producing line can be employed as the detection electrodes 31 and 32. The material is, for example, Al, Al—Si (which contains minute amounts of Si in such a degree at, for example, less than 1%), Ti, Au, Cu, poly-Si or the like. Incidentally, the electrodes 31 and 32 are composed of Al in this embodiment.

A silicon nitride film 40 is formed on the electrodes 31 and 32 as a second insulation film. Although the silicon nitride film 40 covers gaps formed between the electrodes 31 and 32 as well as the electrodes 31 and 32, the silicon nitride film 40 may only cover the electrodes 31 and 32 and may not cover the gaps.

A humid-sensitive film 50 of which permittivity changes according to humidity is formed on the silicon nitride film 40 so as to cover the electrodes 31 and 32, and the gaps formed therebetween. In this embodiment, the humid-sensitive film 50 is disposed between the electrodes 31 and 32 so that a lower surface thereof is located lower than surfaces of the electrodes 31 and 32, whereby the humid-sensitive film 50 is interposed between the electrodes 31 and 32.

A hygroscopic macro molecule organic material can be employed as the humid-sensitive film 50. Specifically, polyimide or butyric acetylcellulose or the like can be employed. In this embodiment, the film 50 is composed of polyimide. When water molecular is absorbed in the film 50, permittivity of the film 50 changes according to amount of absorbed water molecular since water molecular has high permittivity to thereby cause change in capacitance between the detection electrodes 51 and 52.

An area where the humid-sensitive film 50 is located on the semiconductor substrate 10 constitutes a humid-sensing portion 100. Namely, ambient humid of the humid-sensing portion 100 is detected based on the capacitance formed between the detection electrodes 31 and 32 that changes according to change in humidity around the sensor S1.

A circuit element portion 200 is formed in an area except the area where the humid-sensing portion 100 is located (a periphery of the humid-sensing portion 100, which is indicated as a hatching area in FIG. 1). The circuit element portion 200 produces a signal that shows the value of the capacitance formed between the detection electrodes 31 and 32.

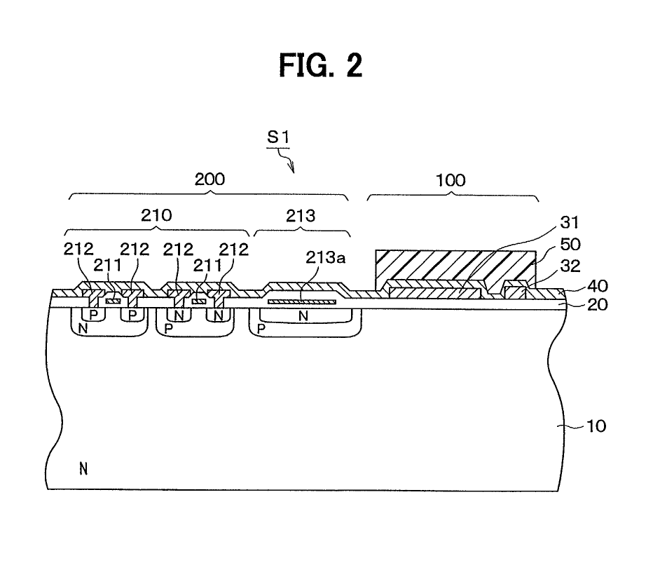

As shown in FIG. 2, the circuit element portion 200 includes a C-MOS transistor 210 in this embodiment. The C-MOS transistor 210 has a P-channel MOS transistor and a N-channel MOS transistor each of which has a gate electrode 211 composed of poly-Si, Al wirings that are electrically conducted to a source and a drain. Moreover, the C-MOS transistor 210 has a reference capacitance portion 213 which has a wiring electrode 213a composed of poly-Si.

Incidentally, the C-MOS transistor 210 may have other circuit element such as bi-polar transistor or the like. In this embodiment, although not shown in FIG. 2, an oscillating circuit 350 is formed, which will be described later.

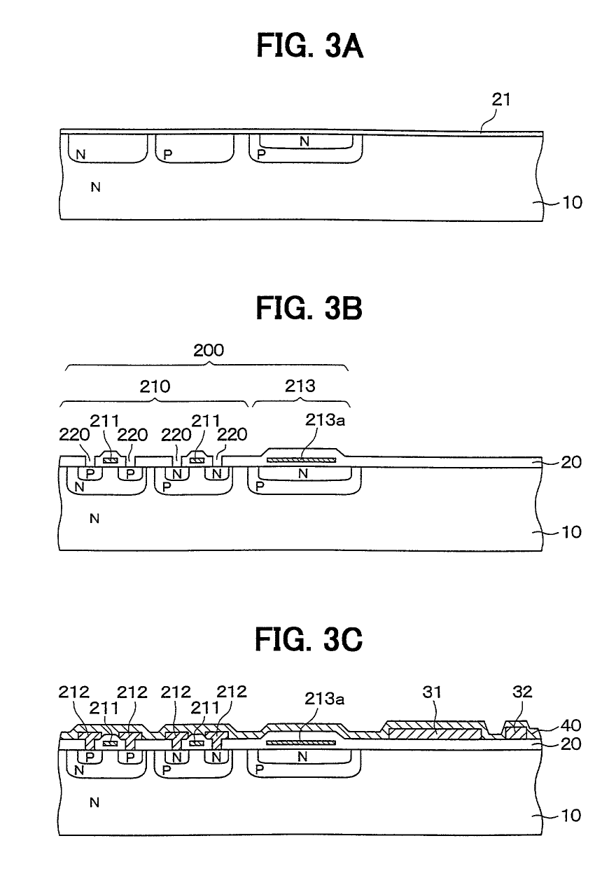

Next, a manufacturing process will be explained with reference to FIGS. 3A to 3C.

As shown in FIG. 3A, diffusion regions and thermal oxidation film 21 are formed on the silicon substrate 10 by ion implantation, thermal diffusion and thermal oxidizing. Successively, as shown in FIG. 3, source and drain diffusion regions and poly-Si electrodes 211, 213a are formed on the silicon substrate 10 by ion implantation, thermal diffusion, CVD (Chemical Vapor Deposition) and patterning, whereby the circuit element portion 200 is formed on the silicon substrate 10.

Successively, a silicon oxide film is formed on the thermal oxidation film by CVD to form a silicon oxide film 20 as the first insulation film with the thermal oxidation film 21.

Further, as shown in FIG. 3A, contact holes 200 for making electrical contact between the circuit element portion 200 and wiring electrodes thereof are formed in the silicon oxide film 20 by etching using photolithography method.

Next, as shown in FIG. 3, the wiring electrodes of the circuit element portion 200 and the detection electrodes 31 and 32 for detecting change in humidity are formed by sputtering method or deposition method using Al or the like. The silicon nitride film 40 (second insulation film) is formed on the electrodes by plasma CVD or the like.

Successively, pad portions (not shown) for connecting the circuit element portion 200 to external device are opened in the silicon nitride film 40.

Finally, the humid-sensitive film 50 is formed on the silicon nitride film 40 by a method in which polyimide is formed on the nitride film 40 by spin coating, and is hardened and then is patterned by photo-etching, or a method in which polyimide is formed on the nitride film 40 by printing method and is hardened. Thus, the capacitance type humid sensor S1 is completed in the usual semiconductor producing line.

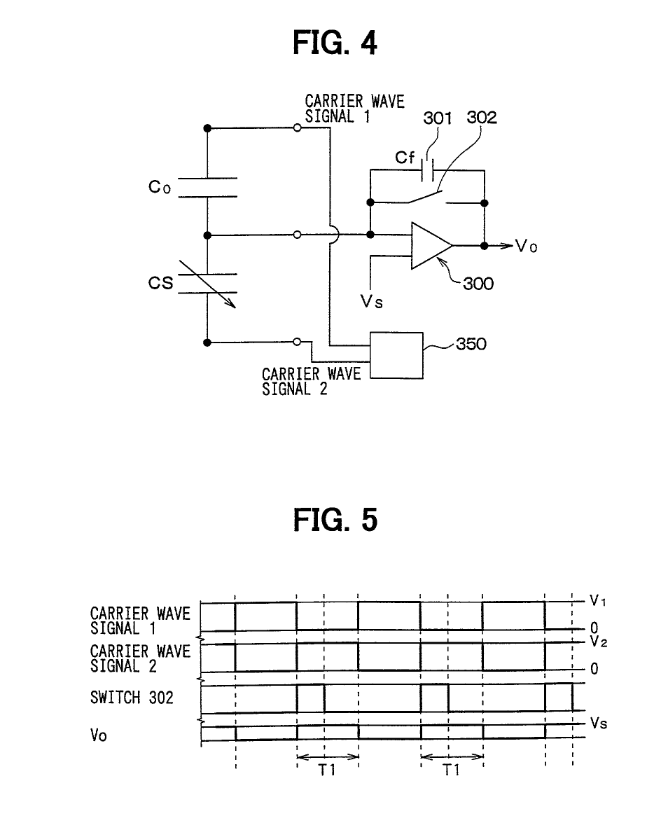

Next, an operation of the sensor S1 will be explained with reference to FIG. 4. In the sensor S1, the respective detection electrodes 31 and 32 are electrically connected to the circuit element portion 200 to form a switched capacitor circuit as shown in FIG. 4.

CS denotes a variable capacitance formed by the detection electrodes 31 and 32 facing with each other, which changes according to humidity in the circumstance. Co is a reference capacitance which is formed between the wiring electrode 213a and the silicon substrate 10 disposed below at the reference capacitance portion 213.

A differential amplifier circuit 300 consists of the C-MOS transistor 210 and the like to detect intermediate potential between the reference capacitance Co and the variable capacitance CS. The differential amplifier circuit 300 has a switch 302 and a capacitor 301 having capacitance Cf. A reference potential Vs is inputted to the amplifier circuit 300.

Moreover, the circuit element portion 200 has an oscillating circuit 350 for sending carrier wave signals in reversed phase from each other respectively to one electrode of the reference capacitance Co (for example, the silicon substrate 10) and one of the detection electrodes 31 and 32 (one electrode of the variable capacitance CS). A sample chart of waveforms associated with the detection circuit is shown in FIG. 5.

A carrier wave signal 1 (an amplitude: 0-V1) is impressed on the one electrode of the reference capacitance Co, and a carrier wave signal 2 (an amplitude: 0-V2) 180° out of phase with the carrier wave 1 is impressed on the one electrode of the variable capacitance CS. The switch 302 is turned on and off according to timing shown in FIG. 5.

The intermediate potential formed between the variable capacitance CS and the reference capacitance Co is outputted as an output voltage Vo through the differential amplifier circuit 300 at detection period T1. At this time, the variable capacitance CS changes in accordance with humidity of the circumstance while the reference capacitance Co does not change, to thereby cause change in the intermediate potential. Namely, the humidity can be detected using the output voltage Vo.

In this embodiment, since the silicon nitride film 40 is interposed between the detection electrodes 31, 32 and the humid-sensitive film 50, the detection electrodes 31 and 32 is protected against water passing through the humid-sensitive film 50, whereby moisture resistance of the detection electrodes 31 and 32 can be secured.

Therefore, it is not necessary to use a particular metal having excellent moisture resistance such as a precious metal for the detection electrodes 31 and 32, and therefore a material (for example, aluminum) that does not become a contaminant in the usual semiconductor producing line can be employed as the detection electrodes 31 and 32.

Moreover, a leak current can be prevented from flowing between the detection electrodes 31 and 32 by interposing the silicon nitride film 40 therebetween. Incidentally, detection electrodes of the resistance detection type sensor mainly disclosed in JP-A-7-20080 cannot be covered with an insulation film because current is to flow between the electrodes.

As described above, a capacitance type humidity sensor can be provided that can be composed of a material capable of using the usual semiconductor producing line and has high reliability.

Furthermore, usual semiconductor producing technique can be employed to process before forming the humid-sensitive film 50, so that high integration and miniaturization of the sensor including the detection electrodes 31 and 32 can be achieved. Especially, polyimide is suitable for the semiconductor process since it is usually used for a protection film for a semiconductor device.

Moreover, in this embodiment, the circuit element portion 200 and the detection electrodes 31, 32 are integrated in the identical silicon substrate 10, so that stray capacitance can be prevented from increasing that is formed therebetween. As a result, S/N can be improved so that the detection electrodes 31 and 32 can be miniaturized to thereby miniaturize size of the capacitance type humidity sensor.

Preferably, a material capable of coating and being hardened at a temperature of 400° C. or less is employed for the humid-sensitive film 50 because treatment at a temperature of 400° C. or less may not influence to property of semiconductor element. Incidentally, polyimide can be hardened at a temperature of 350° C.

Preferably, the detection electrodes 31 and 32 are composed of an identical material with the wiring electrodes 212 formed in the circuit element portion 200, so that the electrodes 31 and 32 are formed in the same process as that for forming the wiring electrodes of the circuit element portion 200.

For example, in the step shown in FIG. 3C, the detection electrodes 31, 32 and the wiring electrodes of the circuit element portion 200 can be formed by sputtering method or deposition method using Al at the same time, so that the number of process can be decreased. Moreover, a mask for forming the detection electrodes 31 and 32 is not required.

Further, although other material can be employed as the second insulation film to cover the detection electrodes 31 and 32, silicon nitride film is suitable since it has relatively high permittivity among insulation films, thereby decreasing loss of capacitance between the detection electrodes 31 and 32, so that sensitivity in detection can be higher.

Preferably, a material that has a lower permittivity in comparison with silicon nitride film is employed as the first insulation film, such as silicon oxide film, although silicon nitride film can be employed as the first insulation film. Such kind of material can decrease parasitic capacitance between the detection electrodes 31, 32 and the silicon substrate 10, so that sensitivity in detection can be higher.

Moreover, as shown in FIG. 2, since the humid-sensitive film 50 is disposed lower than the surfaces of the detection electrodes 31 and 32, the humid-sensitive film 50 is disposed in the gap formed between the detection electrodes 31 and 32 to thereby increasing sensitivity in detection.

Moreover, the circuit element portion 200 includes the switched capacitor circuit that converts change in capacitance to voltage. The switched capacitor circuit can sensitively detect minute change in capacitance, so that the detection electrodes can be miniaturized.

Incidentally, it is not necessarily to integrate the humid-sensing portion 100 with the circuit element portion 200. In this case, a chip or board containing the circuit element portion 200 can be electrically connected to the substrate having the humid-sensing portion 100 by lead wirings or bonding wirings.

While the present invention has been shown and described with reference to the foregoing preferred embodiment, it will be apparent to those skilled in the art that changes in form and detail may be therein without departing from the scope of the invention as defined in the appended claims.

What is claimed is:

1. A capacitance type humidity sensor comprising:
a semiconductor substrate;
a first insulation film formed on the semiconductor substrate;
two electrodes formed on the first insulation film so as to facing with each other with a gap interposed therebetween at an identical plane;
a second insulation film formed on the two electrodes so as to cover the two electrodes; and
a humid-sensitive film formed on the second insulation film to cover the two electrodes, the humid-sensitive film having a capacitance which changes according to humidity, wherein a capacitance formed between the two electrodes changes according to ambient humidity of said sensor.

2. A capacitance type humidity sensor according to claim 1, further comprising:
a circuit portion formed on the semiconductor substrate to process a signal that contains a change in the capacitance formed between the two electrodes.

3. A capacitance type humidity sensor according to claim 2, wherein the two electrodes are composed of a material identical with wiring material formed in the circuit portion.

4. A capacitance type humidity sensor according to claim 2, wherein the circuit portion has a switched capacitor circuit which converts the change in the capacitance formed between the two electrodes.

5. A capacitance type humidity sensor according to claim 1, wherein the second insulation film includes silicon nitride.

6. A capacitance type humidity sensor according to claim 5, the first insulation film is composed of a material that has lower permittivity in comparison with silicon nitride.

7. A capacitance type humidity sensor according to claim 1, wherein the humid-sensitive film has a hygroscopic macro-molecule organic material.

8. A capacitance type humidity sensor according to claim 1, wherein the respective two electrodes have a plurality of tooth portions, each of the plurality of tooth portions of one of the electrodes is engaged with each of the plurality of tooth portions of the other of the electrodes.

9. A capacitance type humidity sensor according to claim 1, wherein the two electrodes are one selected from a group consisting of Al, Al—Si, Ti, Au, Cu, poly-Si.

10. A capacitance type humidity sensor according to claim 1, wherein the two electrodes are a combination made by two or more selected from a group consisting of Al, Al—Si, Ti, Au, Cu, poly-Si.

11. A capacitance type humidity sensor according to claim 1, wherein the humid-sensitive film is disposed lower than surfaces of the two electrodes.

12. A manufacturing method of capacitance type humidity sensor, comprising the steps of:
forming a first insulation film on a semiconductor substrate after a circuit portion is formed on a semiconductor substrate;
forming wiring electrode of the circuit portion and two electrodes for detecting change in capacitance on the first insulation film;
forming a second insulation film is formed on the two electrodes; and
forming a humid-sensitive film on the second insulation film so as to cover the two electrodes, wherein the humid-sensitive film has a capacitance which changes according to humidity.

13. A manufacturing method of capacitance type humidity sensor according to claim 12, wherein the two electrodes and the wiring electrode of the circuit portion are formed at a same time.
